(19) United States
(12) Patent Application Publication
(10) Pub. No.: US 2026/0205499 A1
(43) Pub. Date: Jul. 16, 2026

(54) Cloud-Based Policy Enforcement and Risk Controls Based on Geopolitical, Geographic, Geological, and Idealistic Insights

(71) Applicant: Zscaler, Inc., San Jose, CA (US)

(72) Inventors: Nathan Howe, San Jose, CA (US); James Tucker, Stockholm (SE); Arvind Nadendla, San Jose, CA (US); Eric Cheung, San Jose, CA (US)

(73) Assignee: Zscaler, Inc., San Jose, CA (US)

(21) Appl. No.: 19/019,630

(22) Filed: Jan. 14, 2025

(51) Int. Cl. H04L 9/40

(52) U.S. Cl. CPC H04L 63/20; H04L 63/1433

(57) ABSTRACT

Systems and methods for cloud-based policy enforcement and risk controls based on geopolitical insights include ingesting external data feeds from a plurality of sources, the external data feeds providing information indicative of geopolitical factors; analyzing the ingested data to classify one or more geographic regions, networks, or user populations into risk categories; determining, for each tenant of the cloud-based system, a level of acceptable risk tolerance that defines actions to be taken upon assignment of a particular risk category to a region or user population; and applying, based on the determined risk tolerance and assigned risk category, one or more adaptive cybersecurity controls.

### FIELD OF THE DISCLOSURE

The present disclosure generally relates to network and cloud security. More particularly, the present disclosure relates to systems and methods for cloud-based policy enforcement and risk controls based on geopolitical, geographic, geological, and idealistic insights.

### BACKGROUND OF THE DISCLOSURE

In an increasingly interconnected world, cyber threats are heavily influenced by geopolitical, geographic, geological, and idealistic events such as conflicts, sanctions, natural disasters, and shifting international alliances. Traditional cybersecurity solutions often rely on static policies that cannot adapt quickly to the evolving global threat landscape. As a result, organizations face a heightened risk of data breaches, service disruptions, and compliance violations when geopolitical tensions escalate. The present invention addresses these challenges by introducing a dynamic, cloud-based framework that ingests data from diverse external sources, assesses regional and political risk factors in real time, and adjusts security policies accordingly. This enables organizations to proactively protect critical assets, maintain regulatory compliance, and preserve business continuity, even amidst rapidly changing geopolitical conditions.

### BRIEF SUMMARY OF THE DISCLOSURE

The present disclosure relates to systems and methods for cloud-based policy enforcement and risk controls based on geopolitical, geographic, geological, and idealistic insights. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include ingesting external data feeds from a plurality of sources, the external data feeds providing information indicative of geopolitical factors; analyzing the ingested data to classify one or more geographic regions, networks, or user populations into risk categories; determining, for each tenant of the cloud-based system, a level of acceptable risk tolerance that defines actions to be taken upon assignment of a particular risk category to a region or user population; and applying, based on the determined risk tolerance and assigned risk category, one or more adaptive cybersecurity controls.

The steps can further include wherein the geopolitical factors include at least one of conflicts, treaties, alliances, crises, health-related events, environmental disasters, and trade policy changes. The risk categories can include at least one of “cautionary,” “elevated,” “risky,” and “threat,” each risk category defining a corresponding set of security responses. The cybersecurity controls can include at least one of blocking traffic, isolating communications, increasing authentication requirements, or implementing heightened inspection of data flows, thereby dynamically adjusting an organization's cybersecurity posture in real time in accordance with evolving geopolitical threats. The steps can further include displaying, on a graphical user interface, a visual representation of geopolitical regions, wherein each region is color-coded or otherwise visually distinguished to reflect its assigned risk category. The external data feeds can include feeds from at least one of government bodies providing data on wars, crises, or treaties, international health organizations providing disease outbreak or pandemic data, environmental monitoring services providing data on natural disasters, and global regulatory or policy aggregators providing information on sanctions, trade restrictions, and electoral changes. The cybersecurity controls can include automatically adjusting connectivity parameters and access privileges for users traveling to or from high-risk regions, including enforcing additional authentication steps, restricting access to sensitive applications, or temporarily suspending certain user privileges. The steps can include enabling exceptions for known and trusted entities operating within a high-risk region, thereby allowing essential business functions to continue while maintaining heightened overall security. The steps can include providing a policy configuration interface that allows administrators of each tenant to define acceptable risk tolerance levels, specify which controls to activate at each risk category, and visualize, via a user interface, the geopolitical risk landscape for informed decision-making. The applied cybersecurity controls can be tiered, such that at a “cautionary” level, users receive warning messages and enhanced traffic inspection, at an “elevated” level, stricter access controls or additional authentication measures are employed, at a “risky” level, traffic and communications are isolated to secure environments, and at a “threat” level, all connections from a designated region are blocked.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring and protection of a user.

FIG. 1B is a logical diagram of the cloud operating as a zero-trust platform.

FIG. 2 is a block diagram of a server.

FIG. 3 is a block diagram of a computing device.

FIG. 4 is a diagram of an exemplary network configuration illustrating an application on computing devices configured to operate through the cloud.

FIG. 5 is a screenshot of a User Interface (UI) provided by the present systems via the cloud-based system.

FIG. 6 is a flowchart of a process for policy enforcement and risk controls based on geopolitical insights.

### DETAILED DESCRIPTION OF THE DISCLOSURE

Again, the present disclosure relates to systems and methods for cloud-based policy enforcement and risk controls based on geopolitical insights. In various embodiments, the present disclosure provides a flexible, cloud-based system that continuously ingests and analyzes geopolitical and environmental data from diverse external sources, such as government advisories, crisis trackers, health organizations, and environmental monitors, to determine real-time risk levels. These risk levels are then mapped to tenant-defined policies so that security controls can be automatically adjusted as conditions evolve. Specifically, one embodiment may focus on assigning dynamic risk “scores” or “categories” to different geographic regions, while another embodiment centers on tailoring access controls, authentication requirements, and network isolation measures to the assigned risk category. Yet another embodiment addresses compliance, ensuring organizations remain aligned with emerging regulations or sanctions by selectively blocking or limiting traffic to high-risk areas. Across these embodiments, the platform empowers administrators to configure risk thresholds, set acceptable levels of exposure, and receive continuous updates on changing global events. This approach lets tenants maintain security, business continuity, and legal compliance even as geopolitical conditions rapidly shift.

### § 1.0 Cybersecurity Monitoring and Protection Examples

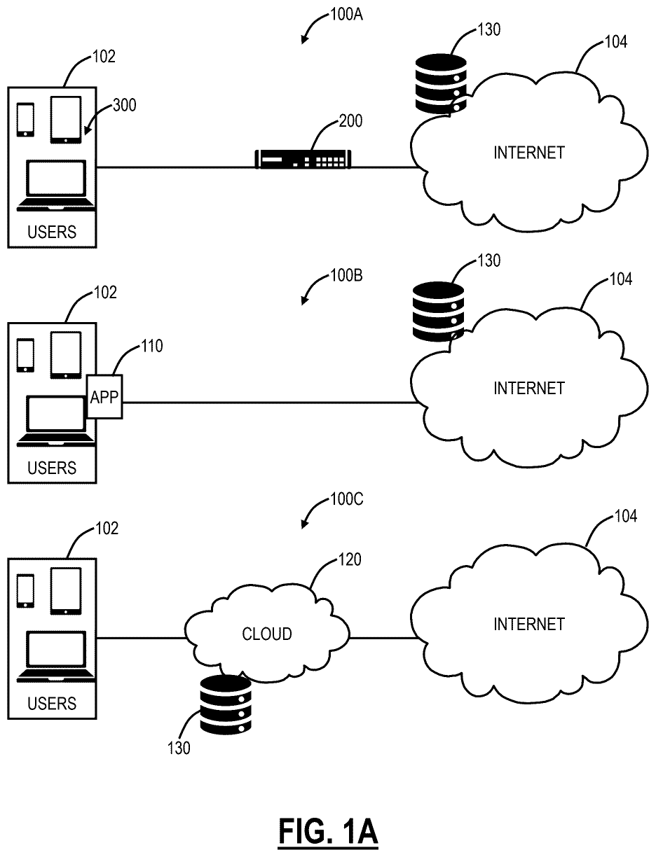

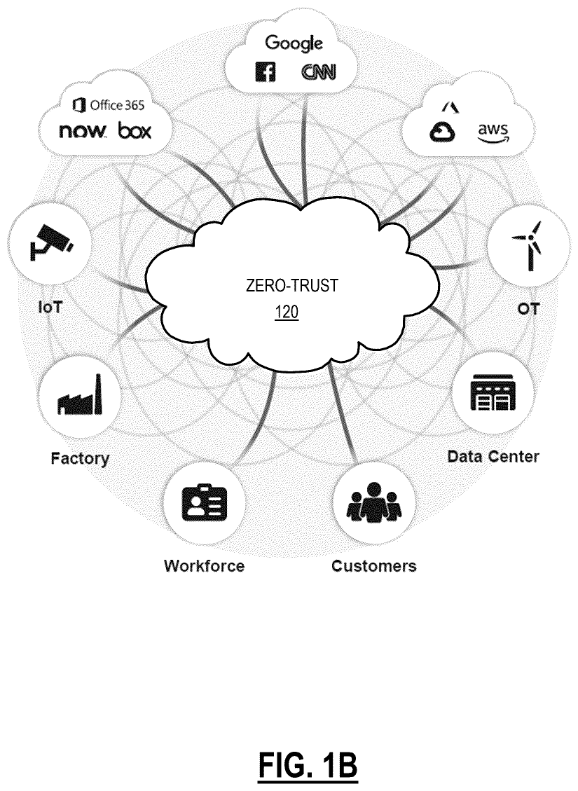

FIG. 1A is a network diagram of three example network configurations 100A, 100B, 100C of cybersecurity monitoring and protection of an endpoint 102. Those skilled in the art will recognize these are some examples for illustration purposes, there may be other approaches to cybersecurity monitoring (as well as providing generalized services), and these various approaches can be used in combination with one another as well as individually. Also, while shown for a single endpoint 102, practical embodiments will handle a large volume of endpoints 102, including multi-tenancy. In this example, the endpoint 102 communicates on the Internet 104, including accessing cloud services, Software-as-a-Service, etc. (each may be offered via computing resources, such as, e.g., using one or more servers 200 as illustrated in FIG. 2).

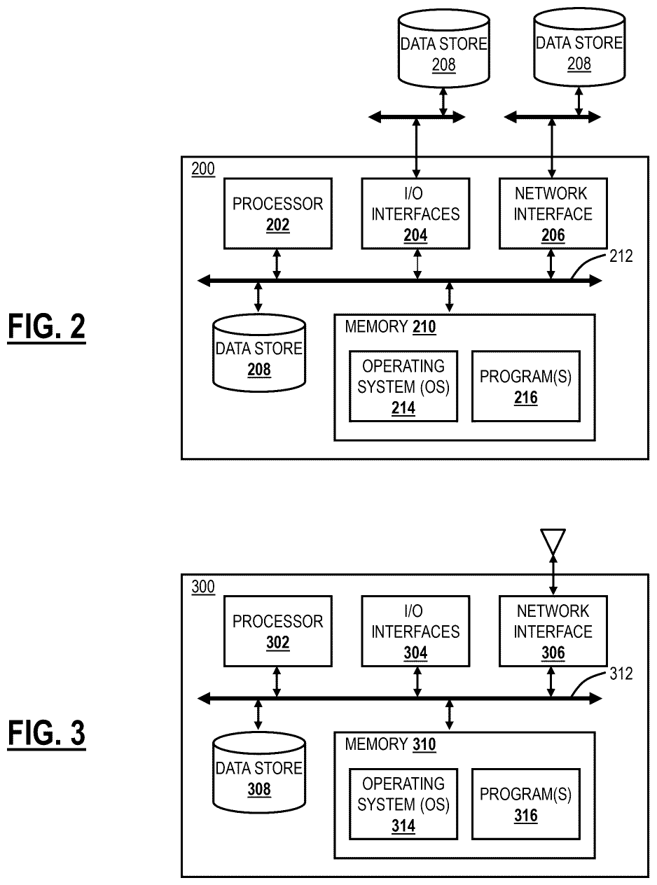

Note, the term endpoint 102 is used herein to refer to any computing device (see FIG. 3 for an example computing device 300) which can communicate on a network. The endpoint 102 can be associated with a user and include laptops, tablets, mobile phones, desktops, etc. Further, the endpoint can also mean machines, workloads, IoT devices, or simply anything associated with the company that connects to the Internet, a Local Area Network (LAN), etc.

As part of offering cybersecurity through these example network configurations 100A, 100B, 100C, there is a large amount of cybersecurity data obtained. Various embodiments of the present disclosure focus on using this cybersecurity data along with a customer's data to perform various security tasks including developing customer machine learning models and other security platforms of the like.

The network configuration 100A includes a server 200 located between the endpoint 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the endpoint 102 and configured to monitor the endpoint 102. In other embodiments, the server 200 does not have to be inline. For example, the server 200 can monitor requests from the endpoint 102 and responses to the endpoint 102 for one or more security purposes, as well as allow, block, warn, and log such requests and responses. The server 200 can be on a local network associated with the endpoint 102 as well as external, such as on the Internet 104. Also, while described as a server 200, this can also be a router, switch, appliance, virtual machine, etc. The network configuration 100B includes an application 110 that is executed on the computing device 300. The application 110 can perform similar functionality as the server 200, as well as coordinated functionality with the server 200 (a combination of the network configurations 100A, 100B). Finally, the network configuration 100C includes a cloud service 120 configured to monitor the endpoint 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the endpoints 102, using signatures sourced and constantly updated. The DNS security can identify and route command-and-control connections to threat detection engines for full content inspection. The DLP can use standard and/or custom dictionaries to continuously monitor the endpoints 102, including compressed and/or Transport Layer Security (TLS) or Secure Sockets Layer (SSL)-encrypted traffic.

In typical embodiments, the network configurations 100A, 100B, 100C can be multi-tenant and can service a large volume of the endpoints 102. Newly discovered threats can be promulgated for all tenants practically instantaneously. The endpoints 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of endpoints 102 under management by an IT group, department, administrator, etc., i.e., some group of endpoints 102 that are managed together. One advantage of multi-tenancy is the visibility of cybersecurity threats across a large number of endpoints 102, across many different organizations, across the globe, etc. This provides a large volume of data to analyze, use machine learning techniques on, develop comparisons, etc. The present disclosure can use the term “service provider” to denote an entity providing the cybersecurity monitoring and a “customer” as a company (or any other grouping of endpoints 102).

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own endpoints 102 and configuration, policy, rules, etc.

### § 1.1 Cloud Monitoring

The cloud 120 can scale cybersecurity monitoring and protection with near-zero latency on the endpoints 102. Also, the cloud 120 in the network configuration 100C can be used with or without the application 110 in the network configuration 100B and the server 200 in the network configuration 100A. Logically, the cloud 120 can be viewed as an overlay network between endpoints 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the endpoints 102, as well as independent of platform, operating system, network access technique, network access provider, etc.

There are various techniques to forward traffic between the endpoints 102 and the cloud 120. A key aspect of the cloud 120 (as well as the other network configurations 100A, 100B) is that all traffic between the endpoints 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software-as-a-Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QoS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120. Zero trust is a cybersecurity strategy where security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multi-factor authentication (MFA) approaches beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

At its core are three tenets:
Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time—before it reaches its destination—to prevent ransomware, malware, and more.
Protect data using granular context-based policies: Zero trust policies verify access requests and rights based on context, including user identity, device, location, type of content, and the application being requested. Policies are adaptive, so user access privileges are continually reassessed as context changes.
Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### § 1.3 Log Data

With the cloud 120 as well as any of the network configurations 100A, 100B, 100C, the log data 130 can include a rich set of statistics, logs, history, audit trails, and the like related to various endpoint 102 transactions. Generally, this rich set of data can represent activity by an endpoint 102. This information can be for multiple endpoints 102 of a company, organization, etc., and analyzing this data can provide a wealth of information as well as training data for machine learning models.

The log data 130 can include a large quantity of records used in a backend data store for queries. A record can be a collection of tens of thousands of counters. A counter can be a tuple of an identifier (ID) and value. As described herein, a counter represents some monitored data associated with cybersecurity monitoring. Of note, the log data can be referred to as sparsely populated, namely a large number of counters that are sparsely populated (e.g., tens of thousands of counters or more, and possible orders of magnitude or more of which are empty). For example, a record can be stored every time period (e.g., an hour or any other time interval). There can be millions of active endpoints 102 or more. Examples of the sparsely populated log data can be the Nanolog system from Zscaler, Inc., the applicant.

Also, such data is described in the following:
Commonly-assigned U.S. Pat. No. 8,429,111, issued Apr. 23, 2013, and entitled “Encoding and compression of statistical data,” the contents of which are incorporated herein by reference, describes compression techniques for storing such logs,
Commonly-assigned U.S. Pat. No. 9,760,283, issued Sep. 12, 2017, and entitled “Systems and methods for a memory model for sparsely updated statistics,” the contents of which are incorporated herein by reference, describes techniques to manage sparsely updated statistics utilizing different sets of memory, hashing, memory buckets, and incremental storage, and
Commonly-assigned U.S. patent application Ser. No. 16/851,161, filed Apr. 17, 2020, and entitled “Systems and methods for efficiently maintaining records in a cloud-based system,” the contents of which are incorporated herein by reference, describes compression of sparsely populated log data.

A key aspect here is that the cybersecurity monitoring is rich and provides a wealth of information to determine various assessments of cybersecurity. In some embodiments, the log data 130 can be referred to as weblogs or the like. Of note, with various cybersecurity monitoring techniques via the network configurations 100A, 100B, 100C, as well as with other network configurations, the log data 130 is a rich repository of endpoint 102 activity. Unlike websites, specific cloud services, application providers, etc., cybersecurity monitoring can log almost all of a user's 102 activity. That is, the log data 130 is not merely confined to specific activity (e.g., a user's 102 social networking activity on a specific site, a user's 102 search requests on a specific search engine, etc.).

### § 2.0 Example Server Architecture

FIG. 2 is a block diagram of a server 200, which may be used as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc.

### § 3.0 Example Computing Device Architecture

FIG. 3 is a block diagram of a computing device 300, which may be realize an endpoint 102. Specifically, the computing device 300 can form a device used by one of the endpoints 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like, i.e., anything that can communicate on a network. The computing device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the computing device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the computing device 300, a semiconductor-based microprocessor (in the form of a microchip or chipset), or generally any device for executing software instructions. When the computing device 300 is in operation, the processor 302 is configured to execute software stored within the memory 310, to communicate data to and from the memory 310, and to generally control operations of the computing device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the computing device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Application for Traffic Forwarding and Monitoring

Again, the network configuration 100B includes an application 110 that is executed on the computing device 300. The application 110 can perform similar functionality as the server 200, as well as coordinated functionality with the server 200 (a combination of the network configurations 100A, 100B). Of course, various embodiments are contemplated herein, including combinations of the network configurations 100A, 100B, 100C together. For example, the application 110 can perform similar functionality as the cloud 120, as well as coordinated functionality with the cloud 120.

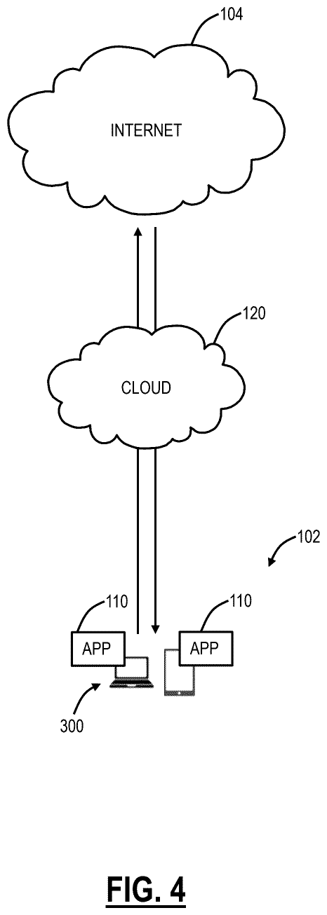

FIG. 4 is a network diagram of an exemplary network configuration illustrating an application 110 on computing devices 300 configured to operate through the cloud 120. Different types of computing devices 300 are proliferating, including Bring Your Own Device (BYOD) as well as IT-managed devices. The conventional approach for a computing device 300 to operate with the cloud 120 as well as for accessing enterprise resources includes complex policies, VPNs, poor user experience, etc. The application 110 can automatically forward user traffic with the cloud 120 as well as ensuring that security and access policies are enforced, regardless of device, location, operating system, or application. The application 110 automatically determines if a user 102 is looking to access the open Internet 104, a SaaS app, or an internal app running in public, private, or the datacenter and routes mobile traffic through the cloud 120. The application 110 can support various cloud services, including ZIA, ZPA, ZDX, etc., allowing the best in class security with zero trust access to internal applications. As described herein, the application 110 can also be referred to as a connector application.

The application 110 is configured to auto-route traffic for seamless user experience. This can be protocol as well as application-specific, and the application 110 can route traffic with a nearest or best fit node of the cloud 120. Further, the application 110 can detect trusted networks, allowed applications, etc. and support secure network access. The application 110 can also support the enrollment of the computing device 300 prior to accessing applications, the internet, or any services provided by the cloud 120. The application 110 can uniquely detect the users 102 based on fingerprinting the user device 300, using criteria like device model, platform, operating system, device posture, etc. The application 110 can support Mobile Device Management (MDM) functions, allowing IT personnel to deploy and manage the computing devices 300 seamlessly. This can also include the automatic installation of client and SSL certificates during enrollment. Finally, the application 110 provides visibility into device and app usage of the user 102 of the computing device 300.

The application 110 supports a secure, lightweight tunnel between the computing device 300 and the cloud 120. For example, the lightweight tunnel can be HTTP-based. With the application 110, there is no requirement for PAC files, an IPSec VPN, authentication cookies, or user 102 setup.

### § 5.0 Policy Enforcement and Risk Controls Based on Geopolitical Insights

As described, the cloud 120 is adapted to provide security via various security services for its tenants. That is, the multi-tenant, cloud-based security platform inspects and filters all user and application traffic, regardless of user location, thereby delivering comprehensive protection against web-based threats and enforcing the security policies defined by each tenant. Rather than routing traffic through on-premises hardware, traffic is directed through a globally distributed network of data centers, where threats are detected and blocked in real time. Each tenant can customize access controls, authentication methods, and content filtering rules to align with its specific security requirements and regulatory mandates. Through continuous monitoring, automatic policy updates, and detailed reporting, the cloud 120, i.e., the cloud-based system, provides a streamlined approach to safeguarding users, data, and workloads across the entire threat landscape.

During periods of geopolitical tension, the frequency and severity of cyber threats rise significantly, adding yet another layer of complexity to an already hazardous digital landscape. Recognizing this elevated risk, the present disclosure introduces systems and methods designed to first quantify the political instability at hand, and then systematically translate these insights into actionable cybersecurity measures. By employing a risk-based approach, the cloud-based system 100 can implement enhanced controls and protocols that serve to both shield vital systems from emerging threats and minimize the overall impact of cyberattacks stemming from such volatile environments.

In addition to strengthening protective defenses, the performed actions support compliance with new or evolving sanctions, regulations, or other restrictions that arise as international relationships shift. This ensures that organizations remain legally and ethically aligned with regional and global mandates, despite rapidly changing political conditions. For instance, if employees reside within a state identified as high-risk due to intensified geopolitical friction, the proposed systems allow them to maintain as much continuity in their work as possible, provided that additional safeguards are introduced. Such measures might include restricting their access to sensitive information, employing stronger authentication protocols, or closely monitoring network activity originating from that region. By taking a balanced approach, one that preserves operational functionality without compromising security, the system facilitates resilience, adaptability, and compliance in even the most uncertain geopolitical climates.

The cloud 120, as a multi-tenant, cloud-based security platform is well-positioned to leverage the present dynamic, geopolitically-informed risk assessment and control mechanisms. By integrating the described risk quantification into the cloud's 120 central policy engine, the platform can help its individual tenants, such as enterprises, government agencies, and other organizations, benefit from more finely tuned and context-aware security policies.

In practical terms, the cloud 120 regularly ingests external data feeds from reputable global sources, such as intelligence agencies, government bodies, health organizations, and environmental monitors. Using this information, the platform can classify regions, networks, and user populations according to the prevailing geopolitical climate or significant events such as armed conflicts, pandemics, state-sponsored cyber campaigns, or natural disasters. These automatically updated classifications inform the tenant's security posture in real time.

For example, if a tenant's employees suddenly need to travel through a high-risk region experiencing conflict, the cloud 120 dynamically applies tighter security policies, such as enhanced authentication, stricter access controls, or additional user monitoring. Similarly, if a previously stable region enters a state of heightened tension or sanctions are imposed, the platform can swiftly adjust its risk parameters, automatically limiting traffic and engagement with suspicious domains or at-risk infrastructure elements associated with that area.

This adaptive approach allows tenants to maintain their own custom-defined risk tolerance levels. They can decide in advance how the platform should respond to escalating geopolitical threats, and the cloud 120, with its various security services, will enforce these directives seamlessly across all users and workloads. In doing so, the cloud 120 not only provides secure connectivity but also ensures that each tenant's policies remain aligned with the latest global events, delivering a proactive and agile defense against emerging cyber risks tied to geopolitical instability.

The present systems and methods are designed to deliver dynamically generated, risk-based insights and establish proactive controls that take into account a wide range of geopolitical factors. Such factors may include, but are not limited to, conditions of war or peace, the formation or dissolution of alliances, the negotiation of treaties or pacts, shifts in strategic decision-making, the outbreak of crises, and the occurrence of environmental disasters. By incorporating these considerations into a geopolitical risk framework, it becomes possible to quantify and integrate these external variables into the cybersecurity domain, adjusting organizational defenses and strategies accordingly.

Through a deliberate, context-sensitive approach, entities, whether they are individual customers, entire nations, or global organizations, can adapt their cybersecurity risk posture based on the evolving geopolitical environment. For instance, if heightened tensions between countries increase the likelihood of state-sponsored cyber-attacks, the risk parameters can be recalibrated to raise alert levels/risk category, enhance protective measures, and limit exposure to certain digital services or partnerships. Conversely, in times of diplomatic accord or renewed peace, it may be appropriate to relax certain controls, optimize cybersecurity investments, or seek new collaborations within regions that were previously considered high-risk.

Ultimately, the present system enables a dynamic, ever-responsive framework for identifying, preparing for, and mitigating cyber threats that arise in step with geopolitical developments. In doing so, organizations are better equipped to protect critical infrastructure, safeguard sensitive information, and maintain operational resilience, even as the global geopolitical landscape continues to shift.

The systems and methods described herein enable organizations to define an acceptable threat landscape and establish a corresponding risk tolerance level aligned with their unique security objectives and operational contexts. By empowering policy owners, i.e., tenants of the cloud 120, to set precise parameters around what constitutes an acceptable or unacceptable threat scenario, these frameworks ensure that decision-makers can tailor their protection measures to their specific needs and risk profiles. For instance, if an enterprise user is traveling through a region currently experiencing conflict or heightened geopolitical tension, the present systems can detect this elevated level of risk and trigger an immediate response. Predefined controls, such as temporarily suspending access to critical systems or instituting stronger authentication requirements, may be automatically applied to safeguard both the individual and the organization's assets.

Beyond purely technological threats, the model accommodates a broad spectrum of potential hazards that stem from physical events, social unrest, or other non-cyber factors. Actors, incidents, and provoked events originating in the physical world can be methodically classified and assessed based on their potential impact on the organization's security posture. This comprehensive approach ensures that even those dangers arising outside the digital domain, be they triggered by environmental crises, political turmoil, or localized conflict, are considered and integrated into a cohesive risk management strategy. Consequently, tenants can maintain agility and resilience in the face of a continually evolving global threat landscape, taking proactive steps to mitigate harm and preserve operational continuity.

A key aspect of the systems and methods involves defining what constitutes a “risk initiator” and determining how such initiators influence the broader threat landscape. These risk initiators are identified using predefined criteria informed by a wide range of authoritative external data sources, including institutions such as the World Health Organization, national Departments of Foreign Affairs, international terrorist watch lists, and geological monitoring services, among others. By integrating these diverse insights, the cloud 120 and policy owners gain a more accurate and comprehensive understanding of the geopolitical and environmental factors that may pose a heightened risk to their operations.

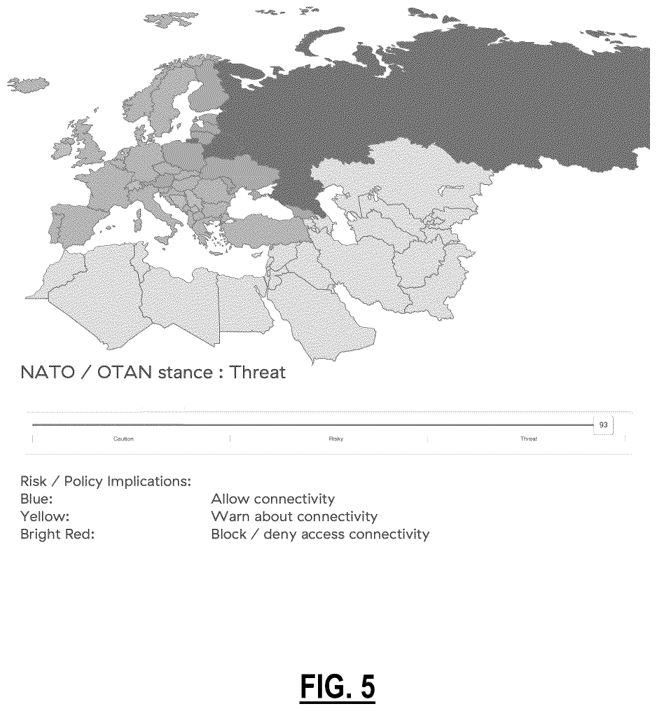

Once various risk levels and tolerances are established and imported into the system, policy owners can fine-tune their response strategies. For example, consider a scenario in which a state emerges as an aggressor in Europe. In this situation, the surrounding and bordering countries, as well as any states openly supporting the aggressor, would all see a quantifiable increase in their associated risk levels/risk categories. FIG. 5 is a screenshot of a UI provided by the present systems via the cloud-based system 120. The present systems are adapted to, based on ingested external feeds, provide a visual representation of geographical areas with specific risk categories assigned thereto. In various embodiments, geographical areas can be color codes to represent an assigned risk category. Additionally, the visual representation and the assignment of risk categories consider, with respect to an area with a high risk category, bordering areas (countries, states, etc.), alliances between areas, participants in aggression, and geopolitical structures (North Atlantic Treaty Organization (NATO), United Nations (UN), etc.).

An escalation would directly impact the enterprise's stance on services, assets, and connections linked to that aggressor's ecosystem. Under these heightened conditions, critical digital resources might be subject to stricter access controls, elevated authentication protocols, or even temporary isolation from certain networks. In essence, potentially “risky” assets, whether they are users, systems, or third-party partners, would be handled according to a tiered policy structure that responds dynamically to the evolving geopolitical climate, ensuring that risk mitigation efforts remain robust, agile, and proportionate to the emerging threats.

As described, a comprehensive set of categories can be established by drawing upon a wide variety of external data sources, covering everything from government advisories and regulatory statuses to global crisis tracking and election calendars. These categories function as intelligence feeds, providing timely and context-rich data that can inform the present systems. By proactively monitoring and analyzing events at the international and regional level, the present systems can stay up-to-date with current conditions, emerging conflicts, or newly imposed sanctions.

For example, in various embodiments, the system can obtain regularly updated feeds from the U.S. State Department, which offers information on wars, crises, treaties, and public health concerns. Another source can include the International Crisis Group, tracking conflict zones and hotspot developments, or Australian Smart Traveler advisories, which highlight safe travel locations and areas of unrest. Similarly, the World Trade Organization can keep the system informed of shifts in trade dynamics that may affect supply chains, while the World Health Organization provides insight into health-related crises such as pandemics or endemic diseases that could disrupt operations. Additionally, platforms such as Resource Watch can shed light on environmental factors, ranging from hurricanes to volcanic eruptions, that might pose physical threats, while globally curated election calendars, such as those maintained by the National Democratic Institute, help organizations anticipate political shifts and electoral unrest.

By incorporating these diverse feeds into the present risk management platform, also referred to as the system, and the platform, the present system can continuously update its threat landscape, making informed decisions about policy actions. Further, tenants can, based on the information provided by the present system, perform resource allocation, policy adjustments, and security controls. This level of situational awareness ensures that businesses remain resilient, adaptable, and prepared to respond swiftly in an increasingly interconnected and unpredictable world.

In various embodiments of the present risk management platform, tenant administrators can define their organization's specific “level of acceptance” for different geopolitical and cyber risks. This granular level of control allows each tenant to precisely define what protective measures or restrictions should be enacted as the assessed risk level changes. By establishing a set of predefined risk categories, such as “cautionary,” “elevated,” “risky,” and “threat”, the system can automatically map regions and networks to the appropriate response tier, according to the latest intelligence drawn from external data feeds.

Once the system assigns a risk level to a given region, the tenant's chosen policies, or default policies, will dictate how communications, user access, and data flows are managed. For instance, if a particular geographic area is flagged as “risky,” the tenant's policy might automatically block all incoming traffic from that region, thus preventing potentially dangerous interactions. Likewise, administrators may choose to apply more nuanced controls, allowing for some level of connectivity while imposing stricter authentication and monitoring requirements for access to sensitive applications (applications having sensitive data therein) or data sets. In this way, the system dynamically adapts the organization's cybersecurity posture in real time, offering a flexible and responsive mechanism to maintain optimal levels of security and compliance in an ever-changing global threat landscape.

As risk levels escalate, the present system can apply increasingly stringent controls to services accessed by users located in high-risk regions. At a “cautionary” level, it can be configured to simply inspect network traffic more closely and display a warning page whenever a user attempts to connect from, or to, an application within a designated area. This approach encourages heightened awareness without fully restricting access. As the threat moves into an “elevated” category, the system can impose tighter controls, subjecting data exchanges to more advanced inspection techniques, additional authentication steps, or other safeguards to reduce exposure to potential threats.

If conditions deteriorate further and the environment is deemed “risky,” the system can isolate all communications associated with that location. This action confines potentially compromised traffic to a secure, contained environment and prevents it from interacting freely with sensitive resources. Ultimately, at the most severe “threat” level, the system would block all connections outright, effectively severing digital ties to regions deemed too hazardous for any form of engagement. By scaling responses to these predefined tiers, the system can tailor protective measures for tenants in real time, balancing security needs against business continuity, and ensuring that their cybersecurity posture dynamically adapts to the evolving landscape.

Beyond the above-outlined scenario, a comprehensive range of controls can be implemented when a particular region is classified under a specific risk category. These measures are designed to dynamically adjust security postures and safeguard both information and infrastructure as global conditions evolve. In some cases, this may mean outright blocking all traffic originating from, or destined for, resources within threatening locations, effectively cutting off any potential avenues for malicious infiltration. For regions deemed risky, network administrators might choose to isolate traffic, confining it to controlled environments where critical systems remain beyond reach. At the same time, exceptions may be granted to known and trusted entities, ensuring that essential operations and partnerships can continue unhindered.

As threats intensify, an organization can employ additional inspection protocols, applying advanced filtering and real-time analytics to detect subtle or emerging patterns of malicious behavior. Moreover, heightened security measures, such as multi-factor authentication (2FA), can help verify user identities before granting access. In scenarios where the severity of the threat necessitates a more drastic response, communication channels may be completely isolated, effectively sealing off valuable assets and sensitive information until the risk subsides. By adapting to each category of risk with calibrated responses, organizations can maintain a flexible, proactive defense that continually evolves in step with the global geopolitical landscape.

### § 5.1 Process for Policy Enforcement and Risk Controls Based on Geopolitical Insights

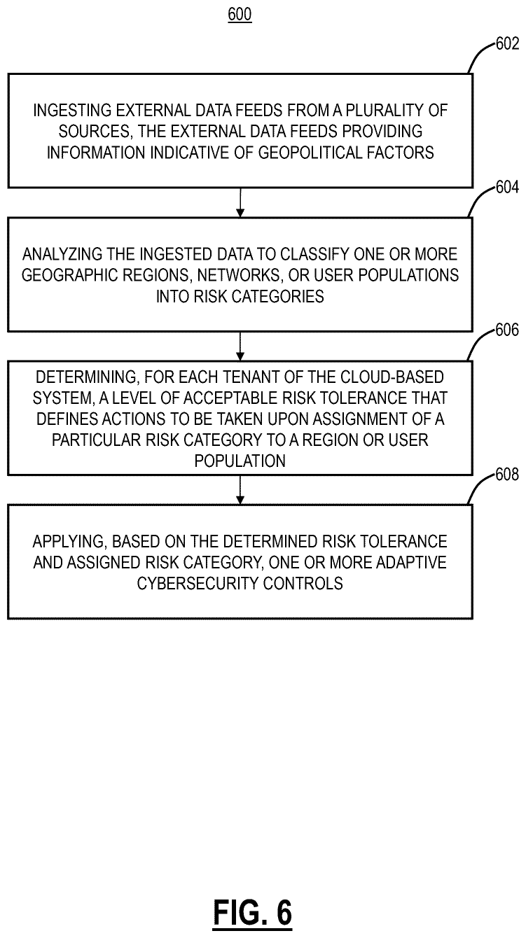

FIG. 6 is a flowchart of a process 600 for policy enforcement and risk controls based on geopolitical insights. In various embodiments, the process 600 can be contemplated as a method having steps, a processing device configured to implement the steps, a cloud-based system configured to implement the steps, and as a non-transitory computer-readable medium storing instructions for programming one or more processors to execute the steps. The process 600 includes ingesting external data feeds from a plurality of sources, the external data feeds providing information indicative of geopolitical factors (step 602); analyzing the ingested data to classify one or more geographic regions, networks, or user populations into risk categories (step 604); determining, for each tenant of the cloud-based system, a level of acceptable risk tolerance that defines actions to be taken upon assignment of a particular risk category to a region or user population (step 606); and applying, based on the determined risk tolerance and assigned risk category, one or more adaptive cybersecurity controls (step 608).

The process 600 further includes wherein the geopolitical factors include at least one of conflicts, treaties, alliances, crises, health-related events, environmental disasters, and trade policy changes. The risk categories can include at least one of “cautionary,” “elevated,” “risky,” and “threat,” each risk category defining a corresponding set of security responses. The cybersecurity controls can include at least one of blocking traffic, isolating communications, increasing authentication requirements, or implementing heightened inspection of data flows, thereby dynamically adjusting an organization's cybersecurity posture in real time in accordance with evolving geopolitical threats. The steps can further include displaying, on a graphical user interface, a visual representation of geopolitical regions, wherein each region is color-coded or otherwise visually distinguished to reflect its assigned risk category. The external data feeds can include feeds from at least one of government bodies providing data on wars, crises, or treaties, international health organizations providing disease outbreak or pandemic data, environmental monitoring services providing data on natural disasters, and global regulatory or policy aggregators providing information on sanctions, trade restrictions, and electoral changes. The cybersecurity controls can include automatically adjusting connectivity parameters and access privileges for users traveling to or from high-risk regions, including enforcing additional authentication steps, restricting access to sensitive applications, or temporarily suspending certain user privileges. The steps can include enabling exceptions for known and trusted entities operating within a high-risk region, thereby allowing essential business functions to continue while maintaining heightened overall security. The steps can include providing a policy configuration interface that allows administrators of each tenant to define acceptable risk tolerance levels, specify which controls to activate at each risk category, and visualize, via a user interface, the geopolitical risk landscape for informed decision-making. The applied cybersecurity controls can be tiered, such that at a “cautionary” level, users receive warning messages and enhanced traffic inspection, at an “elevated” level, stricter access controls or additional authentication measures are employed, at a “risky” level, traffic and communications are isolated to secure environments, and at a “threat” level, all connections from a designated region are blocked.

### § 6.0 Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### § 7.0 Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method implemented by a cloud-based system, the method comprising steps of:
ingesting external data feeds from a plurality of sources, the external data feeds providing information indicative of geopolitical factors;
analyzing the ingested data to classify one or more geographic regions, networks, or user populations into risk categories;
determining, for each tenant of the cloud-based system, a level of acceptable risk tolerance that defines actions to be taken upon assignment of a particular risk category to a region or user population; and
applying, based on the determined risk tolerance and assigned risk category, one or more adaptive cybersecurity controls.

2. The method of claim 1, wherein the geopolitical factors include at least one of conflicts, treaties, alliances, crises, health-related events, environmental disasters, and trade policy changes.

3. The method of claim 1, wherein the risk categories include at least one of “cautionary,” “elevated,” “risky,” and “threat,” each risk category defining a corresponding set of security responses.

4. The method of claim 1, wherein the cybersecurity controls include at least one of blocking traffic, isolating communications, increasing authentication requirements, or implementing heightened inspection of data flows, thereby dynamically adjusting an organization's cybersecurity posture in real time in accordance with evolving geopolitical threats.

5. The method of claim 1, wherein the steps further include displaying, on a graphical user interface, a visual representation of geopolitical regions, wherein each region is color-coded or otherwise visually distinguished to reflect its assigned risk category.

6. The method of claim 1, wherein the external data feeds include feeds from at least one of government bodies providing data on wars, crises, or treaties, international health organizations providing disease outbreak or pandemic data, environmental monitoring services providing data on natural disasters, and global regulatory or policy aggregators providing information on sanctions, trade restrictions, and electoral changes.

7. The method of claim 1, wherein the cybersecurity controls include automatically adjusting connectivity parameters and access privileges for users traveling to or from high-risk regions, including enforcing additional authentication steps, restricting access to sensitive applications, or temporarily suspending certain user privileges.

8. The method of claim 1, wherein the steps include enabling exceptions for known and trusted entities operating within a high-risk region, thereby allowing essential business functions to continue while maintaining heightened overall security.

9. The method of claim 1, wherein the steps include providing a policy configuration interface that allows administrators of each tenant to define acceptable risk tolerance levels, specify which controls to activate at each risk category, and visualize, via a user interface, a geopolitical risk landscape for informed decision-making.

10. The method of claim 1, wherein the applied cybersecurity controls are tiered, such that at a “cautionary” level, users receive warning messages and enhanced traffic inspection, at an “elevated” level, stricter access controls or additional authentication measures are employed, at a “risky” level, traffic and communications are isolated to secure environments, and at a “threat” level, all connections from a designated region are blocked.

11. A non-transitory computer-readable medium comprising instructions that, when executed, cause one or more processors associated with a cloud-based system to perform steps of:
ingesting external data feeds from a plurality of sources, the external data feeds providing information indicative of geopolitical factors;
analyzing the ingested data to classify one or more geographic regions, networks, or user populations into risk categories;
determining, for each tenant of the cloud-based system, a level of acceptable risk tolerance that defines actions to be taken upon assignment of a particular risk category to a region or user population; and
applying, based on the determined risk tolerance and assigned risk category, one or more adaptive cybersecurity controls.

12. The non-transitory computer-readable medium of claim 11, wherein the geopolitical factors include at least one of conflicts, treaties, alliances, crises, health-related events, environmental disasters, and trade policy changes.

13. The non-transitory computer-readable medium of claim 11, wherein the risk categories include at least one of “cautionary,” “elevated,” “risky,” and “threat,” each risk category defining a corresponding set of security responses.

14. The non-transitory computer-readable medium of claim 11, wherein the cybersecurity controls include at least one of blocking traffic, isolating communications, increasing authentication requirements, or implementing heightened inspection of data flows, thereby dynamically adjusting an organization's cybersecurity posture in real time in accordance with evolving geopolitical threats.

15. The non-transitory computer-readable medium of claim 11, wherein the steps further include displaying, on a graphical user interface, a visual representation of geopolitical regions, wherein each region is color-coded or otherwise visually distinguished to reflect its assigned risk category.

16. The non-transitory computer-readable medium of claim 11, wherein the external data feeds include feeds from at least one of government bodies providing data on wars, crises, or treaties, international health organizations providing disease outbreak or pandemic data, environmental monitoring services providing data on natural disasters, and global regulatory or policy aggregators providing information on sanctions, trade restrictions, and electoral changes.

17. The non-transitory computer-readable medium of claim 11, wherein the cybersecurity controls include automatically adjusting connectivity parameters and access privileges for users traveling to or from high-risk regions, including enforcing additional authentication steps, restricting access to sensitive applications, or temporarily suspending certain user privileges.

18. The non-transitory computer-readable medium of claim 11, wherein the steps include enabling exceptions for known and trusted entities operating within a high-risk region, thereby allowing essential business functions to continue while maintaining heightened overall security.

19. The non-transitory computer-readable medium of claim 11, wherein the steps include providing a policy configuration interface that allows administrators of each tenant to define acceptable risk tolerance levels, specify which controls to activate at each risk category, and visualize, via a user interface, a geopolitical risk landscape for informed decision-making.

20. The non-transitory computer-readable medium of claim 11, wherein the applied cybersecurity controls are tiered, such that at a “cautionary” level, users receive warning messages and enhanced traffic inspection, at an “elevated” level, stricter access controls or additional authentication measures are employed, at a “risky” level, traffic and communications are isolated to secure environments, and at a “threat” level, all connections from a designated region are blocked.
